(19) United States
(12) Patent Application Publication
(10) Pub. No.: US 2026/0064859 A1
(43) Pub. Date: Mar. 5, 2026

(54) SYSTEM FOR PROTECTION OF ELECTRONIC DATA USING DIFFERENTIAL PRIVACY NOISED BASED MULTILAYER ENCRYPTION

(71) Applicant: BANK OF AMERICA CORPORATION, CHARLOTTE, NC (US)

(72) Inventors: Shreya Manocha, Gurugram (IN); Saurabh Gupta, Dwarka (IN)

(73) Assignee: BANK OF AMERICA CORPORATION, CHARLOTTE, NC (US)

(21) Appl. No.: 18/820,830

(22) Filed: Aug. 30, 2024

(51) Int. Cl. G06F 21/60; G06F 21/62

(52) U.S. Cl. CPC G06F 21/602; G06F 21/6245

(57) ABSTRACT

A system is provided for protection of electronic data using differential privacy noised based multilayer encryption. In particular, the system may use a multilayer dynamic encryption mechanism to introduce noise elements to the sensitive data stored within a network environment. The system may intelligently determine the number of layers of encryption to apply to the sensitive data as well as the types of algorithms or patterns to use for each layer of encryption based on identifying the level of sensitivity of the information within a particular dataset. The system may further selectively add varying levels of encryption to individual parameters within a given dataset based on the sensitivity of the particular parameters. In this way, the system may provide an intelligent and secure way to protect sensitive data.

### TECHNOLOGICAL FIELD

Example embodiments of the present disclosure relate to a system for protection of electronic data using differential privacy noised based multilayer encryption.

### BACKGROUND

There is a need for an intelligent and secure way to protect sensitive electronic data within a network environment.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for protection of electronic data using differential privacy noised based multilayer encryption. In particular, the system may use a multilayer dynamic encryption mechanism to introduce noise elements to the sensitive data stored within a network environment. The system may intelligently determine the number of layers of encryption to apply to the sensitive data as well as the types of algorithms or patterns to use for each layer of encryption based on identifying the level of sensitivity of the information within a particular dataset. The system may further selectively add varying levels of encryption to individual parameters within a given dataset based on the sensitivity of the particular parameters. In this way, the system may provide an intelligent and secure way to protect sensitive data.

Accordingly, embodiments of the present disclosure provide a system for protection of electronic data using differential privacy noised based multilayer encryption, the system comprising: a processing device; a non-transitory storage device containing instructions when executed by the processing device, cause the processing device to perform the steps of: receiving a dataset associated with a user, wherein the dataset comprises one or more parameters associated with the user; determining a level of sensitivity of each of the one or more parameters; and generating an encrypted dataset from the dataset, wherein generating the encrypted dataset comprises: adding, using a first differential privacy algorithm, a first layer of encryption to the one or more parameters within the dataset based on the level of sensitivity of the one or more parameters; and adding, using a second differential privacy algorithm, a second layer of encryption to the one or more parameters based on the level of sensitivity of the one or more parameters.

In some embodiments, the instructions, when executed by the processing device, further cause the processing device to perform the steps of: storing the encrypted dataset in a user data repository; receiving a request from a third-party computing device to access the user data repository; and transmitting the encrypted dataset to the third-party computing device.

In some embodiments, the third-party computing device is an untrusted computing device, wherein adding the second layer of encryption is in response to determining that the third-party computing device is an untrusted computing device.

In some embodiments, determining the level of sensitivity of the one or more parameters comprises processing the dataset using a Laplace mechanism.

In some embodiments, the first differential privacy algorithm and the second differential privacy algorithm are selected based on the level of sensitivity of each of the one or more parameters.

In some embodiments, adding the first layer of encryption to the one or more parameters and adding the second layer of encryption to the one or more parameters comprises changing a value of at least one digit of at least one parameter of the one or more parameters.

In some embodiments, the one or more parameters comprises at least one of a user name, geographic location, or personal identification number.

Embodiments of the present disclosure also provide a computer program product for protection of electronic data using differential privacy noised based multilayer encryption, the computer program product comprising a non-transitory computer-readable medium comprising code causing an apparatus to perform the steps of: receiving a dataset associated with a user, wherein the dataset comprises one or more parameters associated with the user; determining a level of sensitivity of each of the one or more parameters; and generating an encrypted dataset from the dataset, wherein generating the encrypted dataset comprises: adding, using a first differential privacy algorithm, a first layer of encryption to the one or more parameters within the dataset based on the level of sensitivity of the one or more parameters; and adding, using a second differential privacy algorithm, a second layer of encryption to the one or more parameters based on the level of sensitivity of the one or more parameters.

In some embodiments, the code further causes the apparatus to perform the steps of: storing the encrypted dataset in a user data repository; receiving a request from a third-party computing device to access the user data repository; and transmitting the encrypted dataset to the third-party computing device.

In some embodiments, the third-party computing device is an untrusted computing device, wherein adding the second layer of encryption is in response to determining that the third-party computing device is an untrusted computing device.

In some embodiments, determining the level of sensitivity of the one or more parameters comprises processing the dataset using a Laplace mechanism.

In some embodiments, the first differential privacy algorithm and the second differential privacy algorithm are selected based on the level of sensitivity of each of the one or more parameters.

In some embodiments, adding the first layer of encryption to the one or more parameters and adding the second layer of encryption to the one or more parameters comprises changing a value of at least one digit of at least one parameter of the one or more parameters.

Embodiments of the present disclosure also provide a computer-implemented method for protection of electronic data using differential privacy noised based multilayer encryption, the computer-implemented method comprising: receiving a dataset associated with a user, wherein the dataset comprises one or more parameters associated with the user; determining a level of sensitivity of each of the one or more parameters; and generating an encrypted dataset from the dataset, wherein generating the encrypted dataset comprises: adding, using a first differential privacy algorithm, a first layer of encryption to the one or more parameters within the dataset based on the level of sensitivity of the one or more parameters; adding, using a second differential privacy algorithm, a second layer of encryption to the one or more parameters based on the level of sensitivity of the one or more parameters.

In some embodiments, the computer-implemented method further comprises: storing the encrypted dataset in a user data repository; receiving a request from a third-party computing device to access the user data repository; and transmitting the encrypted dataset to the third-party computing device.

In some embodiments, the third-party computing device is an untrusted computing device, wherein adding the second layer of encryption is in response to determining that the third-party computing device is an untrusted computing device.

In some embodiments, determining the level of sensitivity of the one or more parameters comprises processing the dataset using a Laplace mechanism.

In some embodiments, the first differential privacy algorithm and the second differential privacy algorithm are selected based on the level of sensitivity of each of the one or more parameters.

In some embodiments, adding the first layer of encryption to the one or more parameters and adding the second layer of encryption to the one or more parameters comprises changing a value of at least one digit of at least one parameter of the one or more parameters.

In some embodiments, the one or more parameters comprises at least one of a user name, geographic location, or personal identification number.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for protection of electronic data using differential privacy noised based multilayer encryption, in accordance with an embodiment of the disclosure;

FIG. 2 illustrates an exemplary machine learning subsystem architecture, in accordance with an embodiment of the invention; and

FIG. 3 illustrates a method for protection of electronic data using differential privacy noised based multilayer encryption, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

Sensitive data such as user personal identifiable information (“PII”) may be stored and/or processed by various computing devices and/or applications within an entity's network environment as part of the entity's routine organizational workflows. That said, as the sensitive data is released into the network and permitted to traverse the network through various nodes (e.g., computing devices or applications), such sensitive data may become compromised by unauthorized third parties through a number of vectors or methods with respect to any of the nodes, such as malware, unauthorized access, and/or the like, which may in turn create opportunities for unauthorized parties to gain control over a user's identity. Accordingly, there is a need for a way to protect the sensitive data such that the data remains available to the authorized devices and applications within the network environment while being unavailable to unauthorized third parties.

To address the above concerns among others, the system may use an artificial intelligence (“AI”)/machine learning (“ML”) based engine to apply one or more layers of encryption to the sensitive data using differential privacy techniques. In this regard, the sensitive data may include datasets associated with one or more users, where the parameters within each dataset may include information such as a username, e-mail address, geographic location, personal identifier data, user account identifier, unique characteristic data, biographical information, and/or the like. The system may determine a sensitivity level (e.g., a degree of sensitivity) of the dataset and/or the individual parameters within the dataset.

In some embodiments, determining the sensitivity level of the data set and/or the parameters may comprise using one or more differential privacy algorithms that may include, for instance, a Laplace mechanism function to determine the sensitivity of the parameters and add Laplace noise to the parameters of the dataset depending on the parameter. In this regard, parameters determined to have relatively high sensitivity levels may receive a higher amount of noise, whereas parameters determined to have relatively low sensitivity levels may receive a comparatively lower amount of noise, or in some instances, no noise at all. For instance, parameters such as a user name, contact information, personal identifiers, and/or the like may be encrypted to a higher degree (e.g., more noise may be added), whereas parameters that are less sensitive (e.g., the name of the company at which the user is employed) may be encrypted to a lesser degree (e.g., less noise may be added), or in some cases may have no noise added at all.

After determining the sensitivity level of the dataset and/or its parameters, the system may add a first layer of noise (or “encryption”) to the dataset using a first differential privacy algorithm, where the first differential privacy algorithm may be selected by the system based on the sensitivity of the dataset and/or the parameters therein. The encrypted dataset may then be stored within a user data repository and made available to the other computing devices and/or applications within the network environment. Accordingly, the authorized computing devices and applications may access and use the datasets to drive its workflow processes, whereas the raw or “true” data is known only to a trusted party (e.g., a data curator of the entity). In such a scenario, even if the encrypted dataset were to be intercepted by an unauthorized party, the encryption of the dataset prevents the unauthorized party from discovering the true values of the parameters within the dataset.

In some embodiments, the entity's systems may receive a request for the dataset from an untrusted third-party computing device (e.g., an unauthorized user). Based on the sensitivity of the dataset, the system may select the number of additional layers of noise (e.g., a second layer of noise, a third layer of noise, a fourth layer of noise, and/or the like) to add to a dataset and/or its parameters based on the sensitivity levels of the dataset and/or its parameters. In this regard, particularly sensitive datasets may receive a greater number of additional layers of noise, whereas relatively less sensitive datasets may receive a comparatively lower number of additional layers. The newly encrypted dataset may then be used to fulfill the request from the untrusted third party. The parameters of the encrypted dataset may retain the form and format expected of real parameters within a dataset such that the encrypted parameters may appear indistinguishable from the true or raw parameters. Furthermore, as a result of the differential privacy mechanisms described above, unauthorized users may not ascertain which parameters have been encrypted (and to what degree) and which have not, thereby preventing the compromise of the identity of the user by such unauthorized users.

An exemplary embodiment will be discussed as follows for illustrative purposes only and should not be construed to limit the scope of the disclosure provided herein. In one embodiment, an entity may store various types of information or parameters regarding one or more users associated with the entity (e.g., customers or clients of the entity). Accordingly, the user data in such an embodiment may include customer datasets associated with each customer (e.g., a first dataset associated with a first customer, a second dataset associated with a second customer, and the like). To illustrate, the user data may comprise a dataset associated with a first customer (e.g., “Customer A”). The dataset may specify one or more parameters, such as a customer name (e.g., “A”), customer e-mail address (e.g., “customerA@domain.com”), geographic location (e.g., “XXX. XXX. XXX.123”), personal identification number (e.g., “XXX-XX-4567”), account number (e.g., “XXXXXX980), company name (e.g., “Company-Name”), and/or the like.

Using the AI engine, the system may analyze the customer dataset to determine the level of sensitivity of each of the parameters within the dataset associated with Customer A. Based on the sensitivity of each of the parameters, the system may select a first encryption algorithm (or “first differential privacy algorithm”) and subsequently apply a first layer of encryption to the parameters by encrypting the parameters within the data set using the first encryption algorithm (e.g., algorithm 31). The first encryption algorithm may selectively apply differential levels of encryption and/or masking to the various parameters depending on the sensitivity of such parameters. For instance, one or more digits of sensitive parameters may be changed to (e.g., customer name may be changed to “Customer M,” e-mail address may be changed to “customerM@domain. com,” geographic location may be changed to XXX. XXX. XXX.124, the personal identification number may be changed to XXX-XX-8901, the account number may be changed to XXXXXX157, and/or the like. Certain parameters may be modified to a greater extent than others depending on the sensitivity of the parameter. For instance, highly sensitive parameters such as personal identification number and account number may be encrypted to a greater extent (e.g., a greater number of digits may be changed) than less sensitive parameters. In some embodiments, parameters having low sensitivity may be left unchanged after the first layer of encryption is applied (e.g., the company name may remain “Company-Name”).

The customer data set with the first layer of encryption may be stored within a customer data repository within the network environment such that the customer data is accessible to the applications and devices within the network environment. Upon receiving a request for a portion of the customer data from an untrusted or unauthorized computing device, the system may automatically apply a second layer of encryption to the customer dataset by selecting a second encryption algorithm (e.g., algorithm 42) and encrypting the customer data set further using the second encryption algorithm. The second encryption algorithm (or “second differential privacy algorithm”), which may in some embodiments be different from the first encryption algorithm, may apply different levels to the parameters within the customer dataset, where the parameters encrypted by the second encryption algorithm may be the same or different parameters, in whole or in part, from the parameters of the customer dataset encrypted by the first encryption algorithm. Depending on the sensitivity level of the customer dataset, the system may further determine that additional layers of encryption should be applied to the customer dataset (e.g., adding a third layer of encryption using a third encryption algorithm, a fourth layer of encryption using a fourth encryption algorithm, and the like). The system may then share the encrypted customer dataset with the computing device. In this way, the data shared with the requesting computing device may appear to be authentic data even though the true data has been obfuscated or masked by the one or more layers of encryption.

The system as disclosed herein provides numerous technical advantages over conventional systems for protecting user data. For instance, by applying multiple layers of encryption to the sensitive data, the system may prevent unauthorized third parties from reverse engineering the true or raw user data. Furthermore, by using one or more differential privacy mechanisms, the system may selectively apply a higher level of encryption to the most sensitive parameters within a dataset, thereby increasing the computing efficiency of the encryption process.

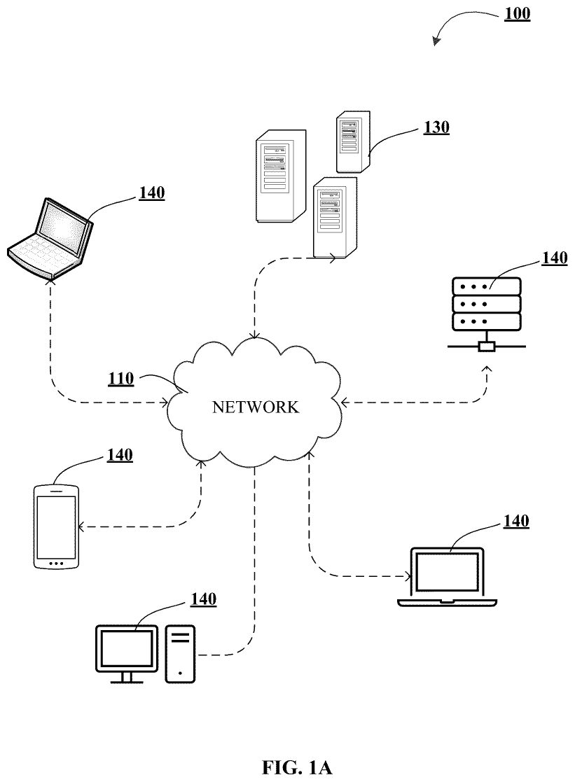

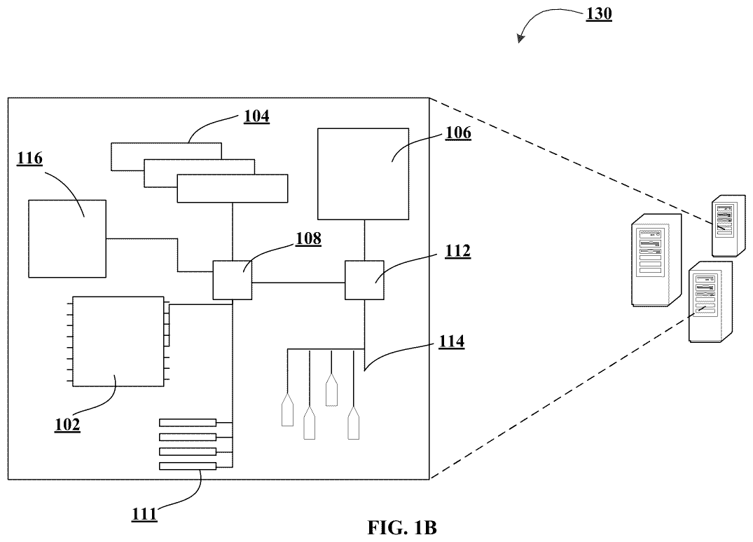

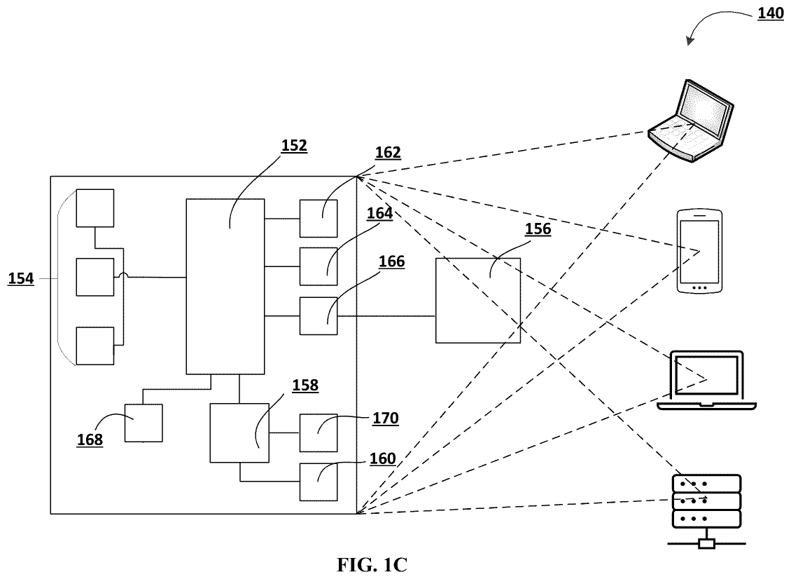

Turning now to the figures, FIGS. 1A-1C illustrate technical components of an exemplary distributed computing environment 100 for the system for protection of electronic data using differential privacy noised based multilayer encryption. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

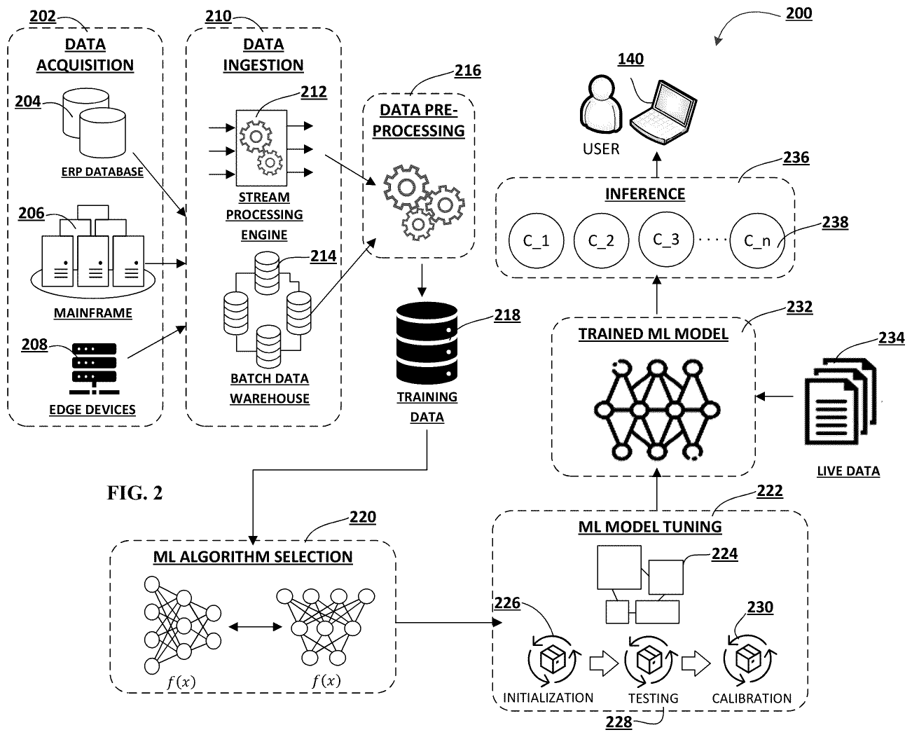

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

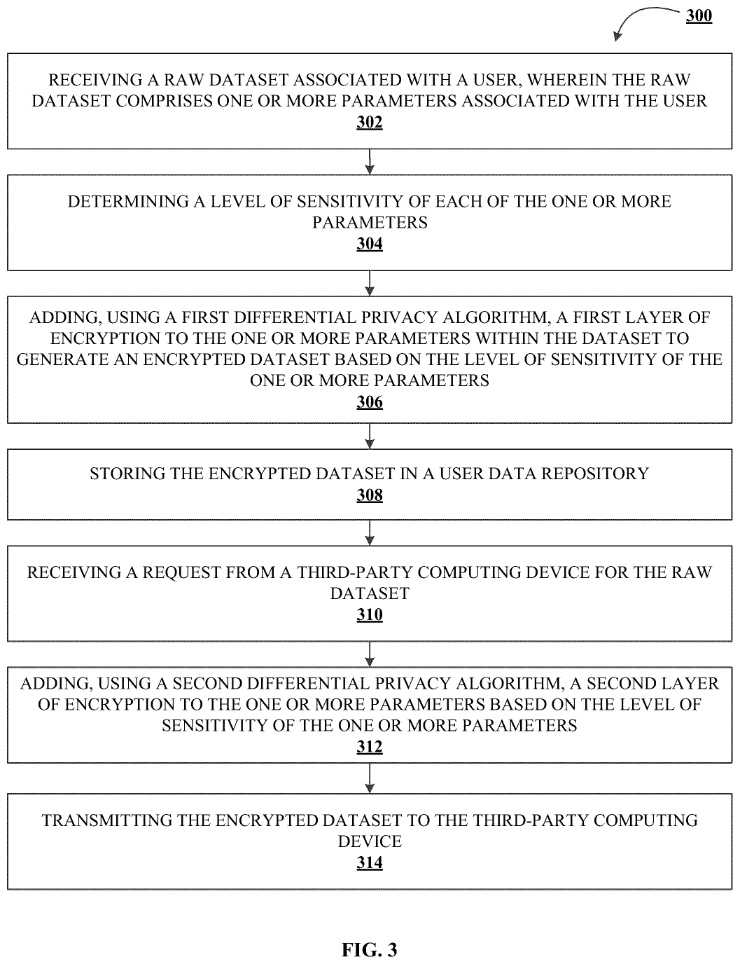

FIG. 3 illustrates a method 300 for protection of electronic data using differential privacy noised based multilayer encryption. As shown in block 302, the method includes receiving a raw dataset associated with a user, wherein the raw dataset comprises one or more parameters associated with the user. The “raw” dataset may reflect the true values of the various parameters associated with the user. In this regard, the parameters may include information regarding the user such as the user name, e-mail address, geographic location, personal identification number, mobile number, account number, biographical information, status information, company name, and/or the like. Accordingly, the dataset may contain sensitive information such as PII associated with the user such that the system may mask the true values of the parameters within the dataset, as described elsewhere in further detail herein.

Next, as shown in block 304, the method includes determining a level of sensitivity of each of the one or more parameters. In some embodiments, determining the level of sensitivity of the various parameters within the data set may comprise processing the data set using a Laplace mechanism. In this regard, the inclusion of certain parameters within the data set may cause the user associated with the parameters to become more identifiable than others. For example, a personal identification number of the user may uniquely identify the user, whereas an approximate geographic location may not. Accordingly, the system may further apply varying levels of noise to the parameters, where more noise is applied to more sensitive parameters and comparatively less noise is added to less sensitive parameters.

Next, as shown in block 306, the method includes adding, using a first differential privacy algorithm, a first layer of encryption to the one or more parameters within the dataset to generate an encrypted dataset based on the level of sensitivity of the one or more parameters. The type of differential privacy algorithm may be intelligently selected by the system based on the sensitivity of the data set and/or the one or more parameters. For instance, if the sensitivity level of the data set and/or parameters falls within a first range (e.g., 1-10), the system may use one differential privacy algorithm, whereas if the sensitivity level falls within a second range (e.g., 11-20), the system may use another differential privacy algorithm.

Next, as shown in block 308, the method includes storing the encrypted dataset in a user data repository. Once the data has been encrypted, the dataset may be released into the network. It should be understood that in other embodiments, the raw dataset may be stored in the user data repository such that the layers of encryption are added after the data set has been stored in the user data repository.

Next, as shown in block 310, the method includes receiving a request from a third-party computing device for the raw dataset. In some embodiments, the third-party computing device may be an unauthorized or untrusted computing device that is attempting to access the user data repository. Accordingly, the system may add additional layers of encryption to the data set before making the data set available to the user, thereby thwarting the unauthorized device's attempts to reverse engineer the true data within the data set.

Next, as shown in block 312, the method includes adding, using a second differential privacy algorithm, a second layer of encryption to the one or more parameters based on the level of sensitivity of the one or more parameters. In some embodiments, the system may change the algorithm used to add noise to the data set with each layer of encryption added. Accordingly, in some embodiments, the first differential privacy algorithm may be different from the second differential privacy algorithm, though it is within the scope of the disclosure for the same algorithm to be used for multiple layers in some scenarios.

Next, as shown in block 314, the method includes transmitting the encrypted dataset to the third-party computing device. The encrypted dataset may have multiple layers of encryption applied to the data set in such a way that the parameters within the data set conform to the formats and standards expected of the parameters. For instance, if the personal identification number associated with the user comprises 10 numerical digits, the encrypted or masked version of the personal identification number will also comprise 10 numerical digits. In this way, the encrypted data appears to be the “true” version of the data set to unauthorized users, thereby preventing the unauthorized use of sensitive data.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for protection of electronic data using differential privacy noised based multilayer encryption, the system comprising:
a processing device;
a non-transitory storage device containing instructions when executed by the processing device, cause the processing device to perform the steps of:
receiving a dataset associated with a user, wherein the dataset comprises one or more parameters associated with the user;
determining a level of sensitivity of each of the one or more parameters; and
generating an encrypted dataset from the dataset, wherein generating the encrypted dataset comprises:
adding, using a first differential privacy algorithm, a first layer of encryption to the one or more parameters within the dataset based on the level of sensitivity of the one or more parameters; and
adding, using a second differential privacy algorithm, a second layer of encryption to the one or more parameters based on the level of sensitivity of the one or more parameters.

2. The system of claim 1, wherein the instructions, when executed by the processing device, further cause the processing device to perform the steps of:
storing the encrypted dataset in a user data repository;
receiving a request from a third-party computing device to access the user data repository; and
transmitting the encrypted dataset to the third-party computing device.

3. The system of claim 2, wherein the third-party computing device is an untrusted computing device, wherein adding the second layer of encryption is in response to determining that the third-party computing device is an untrusted computing device.

4. The system of claim 1, wherein determining the level of sensitivity of the one or more parameters comprises processing the dataset using a Laplace mechanism.

5. The system of claim 1, wherein the first differential privacy algorithm and the second differential privacy algorithm are selected based on the level of sensitivity of each of the one or more parameters.

6. The system of claim 1, wherein adding the first layer of encryption to the one or more parameters and adding the second layer of encryption to the one or more parameters comprises changing a value of at least one digit of at least one parameter of the one or more parameters.

7. The system of claim 1, wherein the one or more parameters comprises at least one of a user name, geographic location, or personal identification number.

8. A computer program product for protection of electronic data using differential privacy noised based multilayer encryption, the computer program product comprising a non-transitory computer-readable medium comprising code causing an apparatus to perform the steps of:
receiving a dataset associated with a user, wherein the dataset comprises one or more parameters associated with the user;
determining a level of sensitivity of each of the one or more parameters; and
generating an encrypted dataset from the dataset, wherein generating the encrypted dataset comprises:
adding, using a first differential privacy algorithm, a first layer of encryption to the one or more parameters within the dataset based on the level of sensitivity of the one or more parameters; and
adding, using a second differential privacy algorithm, a second layer of encryption to the one or more parameters based on the level of sensitivity of the one or more parameters.

9. The computer program product of claim 8, wherein the code further causes the apparatus to perform the steps of:
storing the encrypted dataset in a user data repository;
receiving a request from a third-party computing device to access the user data repository; and
transmitting the encrypted dataset to the third-party computing device.

10. The computer program product of claim 9, wherein the third-party computing device is an untrusted computing device, wherein adding the second layer of encryption is in response to determining that the third-party computing device is an untrusted computing device.

11. The computer program product of claim 8, wherein determining the level of sensitivity of the one or more parameters comprises processing the dataset using a Laplace mechanism.

12. The computer program product of claim 8, wherein the first differential privacy algorithm and the second differential privacy algorithm are selected based on the level of sensitivity of each of the one or more parameters.

13. The computer program product of claim 8, wherein adding the first layer of encryption to the one or more parameters and adding the second layer of encryption to the one or more parameters comprises changing a value of at least one digit of at least one parameter of the one or more parameters.

14. A computer-implemented method for protection of electronic data using differential privacy noised based multilayer encryption, the computer-implemented method comprising:
receiving a dataset associated with a user, wherein the dataset comprises one or more parameters associated with the user;
determining a level of sensitivity of each of the one or more parameters; and
generating an encrypted dataset from the dataset, wherein generating the encrypted dataset comprises:
adding, using a first differential privacy algorithm, a first layer of encryption to the one or more parameters within the dataset based on the level of sensitivity of the one or more parameters; and
adding, using a second differential privacy algorithm, a second layer of encryption to the one or more parameters based on the level of sensitivity of the one or more parameters.

15. The computer-implemented method of claim 14, wherein the computer-implemented method further comprises:
storing the encrypted dataset in a user data repository;
receiving a request from a third-party computing device to access the user data repository; and
transmitting the encrypted dataset to the third-party computing device.

16. The computer-implemented method of claim 15, wherein the third-party computing device is an untrusted computing device, wherein adding the second layer of encryption is in response to determining that the third-party computing device is an untrusted computing device.

17. The computer-implemented method of claim 14, wherein determining the level of sensitivity of the one or more parameters comprises processing the dataset using a Laplace mechanism.

18. The computer-implemented method of claim 14, wherein the first differential privacy algorithm and the second differential privacy algorithm are selected based on the level of sensitivity of each of the one or more parameters.

19. The computer-implemented method of claim 14, wherein adding the first layer of encryption to the one or more parameters and adding the second layer of encryption to the one or more parameters comprises changing a value of at least one digit of at least one parameter of the one or more parameters.

20. The computer-implemented method of claim 14, wherein the one or more parameters comprises at least one of a user name, geographic location, or personal identification number.
